(19) United States
(12) Patent Application Publication
(10) Pub. No.: US 2014/0182254 A1
(43) Pub. Date: Jul. 3, 2014

(54) FILTER DEVICE AND FILTRATION SYSTEM COMPRISED THEREOF

(71) Applicant: BHA Altair, LLC, Franklin, TN (US)

(72) Inventors: Bhalchandra Arun Desai, Smyrna, GA (US); Huong Van Vu, Duluth, GA (US)

(73) Assignee: BHA Altair, LLC, Franklin, TN (US)

(21) Appl. No.: 13/730,066

(22) Filed: Dec. 28, 2012

(51) Int. Cl. B01D 46/00

(52) U.S. Cl. CPC B01D 46/0005
USPC 55/501; 29/402.08

(57) ABSTRACT

This disclosure proposes a new structure for pre-filter devices, and filtration systems in general, that facilitates tasks necessary to maintain performance of pre-filter banks in the filtration system. Embodiments of this structure allow the pre-filter devices to translate on corresponding structural members that make up the supporting structure of the pre-filter bank. When in position, the proposed pre-filter devices can mate with adjacent pre-filter devices to form a substantially unitary structure that prohibits fluid from flowing unfiltered to areas downstream of the filtration system.

### BACKGROUND OF THE INVENTION

The subject matter disclosed herein relates to filters and filtration of fluids and, in one particular implementation, to filtration that occurs in power systems (e.g., gas turbines).

Filtration systems prevent damage that particles can cause to the components in various applications, e.g., gas turbine systems, heating, ventilation, and air conditioning (HVAC) systems, etc. Many filtration systems pass fluid through one or more filter banks and, more particularly, through a pre-filter bank and a final filter bank. The pre-filter bank includes filter devices (also “pre-filter devices”) with filter media that can capture large particles. This filter media, and the pre-filter bank generally, is in place to pro-long the lifespan of the final filter bank, which incorporates filter devices (also “final filter devices”) with filter media of much finer porosity. This finer filter media can clog or become inoperable as a result of impact from particles of large size during operation, e.g. of a gas turbine.

Because the pre-filter devices are subject to more, and larger, particulates, these devices tend to degrade at a much faster rate than the final filter devices. Degraded filters can disrupt fluid flow, thereby increasing the pressure drop through the filtration system. These problems can adversely affect the performance of the system in which the filtration system is used. For example, substantial pressure drops in the filtration system may reduce efficiency and, ultimately, the output of a gas turbine.

Routine maintenance to timely replace the pre-filter devices can address performance of the pre-filter bank. In many cases, scheduled maintenance requires technicians to unfasten the degraded pre-filter devices from the supporting structure and to secure new pre-filter devices in place. But although simple in its description, the maintenance steps can prove costly because pre-filter banks in many filtration systems require hundreds of pre-filter devices that reside in supporting structures that are several stories tall. Thus, the scope of maintenance requires an extensive investment in time, materials, and labor, not to mention costs associated with non-productive downtime of the particular machinery (e.g., gas turbine) on which the maintenance occurs.

Improvements to facilitate maintenance of the pre-filter bank focus on design features to simplify the fastening and unfastening of the filter devices to the supporting structure. These design features do not, however, address any of the other tasks (e.g., lifting and moving the new and degraded pre-filters) that are necessary to completely outfit the pre-filter banks with new pre-filter devices. For example, in addition to the number of pre-filter devices that must be replaced, the physical characteristics (e.g., size and weight) of the pre-filters in both new and degraded condition further compound the difficulties technicians experience when they perform maintenance tasks on pre-filter banks

The discussion above is merely provided for general background information and is not intended to be used as an aid in determining the scope of the claimed subject matter.

### BRIEF DESCRIPTION OF THE INVENTION

This disclosure proposes a new structure for pre-filter devices, and filtration systems in general, that facilitates tasks necessary to maintain performance of pre-filter banks in the filtration system. Embodiments of this structure allow the pre-filter devices to translate on corresponding structural members that make up the supporting structure of the pre-filter bank. When in position, the proposed pre-filter devices can mate with adjacent pre-filter devices to form a substantially unitary structure that prohibits fluid from flowing unfiltered to areas downstream of the filtration system.

This disclosure describes, in one embodiment, a filter frame that includes a frame having an upstream side and a downstream side. The frame bounds a filter receiving area and forms an opening on the upstream side to receive a filter element into the filter receiving area. In one example, the frame includes a protruding element that extends radially away from the filter receiving area. The filter frame also includes a transitory assembly coupled with the filter frame. The transitory assembly has a transitory element disposed on the downstream side of the filter frame.

This disclosure also describes, in one embodiment, a filter frame that includes a frame with an upstream side and a downstream side. The frame includes frame members forming a peripheral boundary to a filter receiving area in which a filter element can reside. The frame member have a protruding element that extends radially away from the filter receiving area. The protruding element has a downstream face that is set off from the downstream side on one or more of the frame members. The filter frame also includes a transitory element coupled with the frame and spaced interior to the peripheral boundary.

This disclosure further describes, in one embodiment, a method for replacing filter devices in a filtration system that has a filter housing and a system structure disposed in the filter housing. The system structure supports the filter devices. The method includes steps for translating a first filter device from a first position to a second position that is laterally offset from the first position in the system structure. The method also includes steps for removing the first filter device from the filtration system at the second position and translating a second filter device to the second position. The method further includes steps for removing the second filter device from the filtration system at the second position.

This brief description of the invention is intended only to provide a brief overview of the subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 depicts a schematic diagram of a side view of an exemplary embodiment of a filter device in a filtration system for use in one application, e.g., a gas turbine system.

FIG. 2 depicts a perspective view of the filtration system of FIG. 1;

FIG. 3 depicts a perspective view of an exemplary embodiment of a filter device in exploded assembly form;

FIG. 4 depicts the filter frame of FIG. 3;

FIG. 5 depicts a side view of the filter device of FIG. 3 in assembled form;

FIG. 6 depicts a back view of an exemplary arrangement of filter devices (e.g., the filter device of FIGS. 3 and 4);

FIG. 7 depicts a perspective view of an exemplary filtration system;

FIG. 8 depicts a top view of the exemplary filtration system of FIG. 6; and

FIG. 9 depicts a flow diagram of a method for performing maintenance on a filtration system, e.g., filtration system of FIGS. 7 and 8.

### DETAILED DESCRIPTION OF THE INVENTION

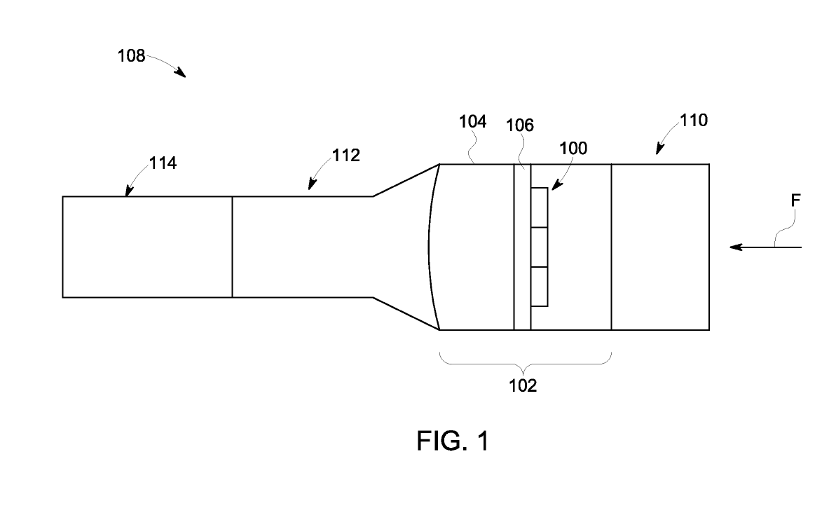

FIG. 1 depicts a schematic diagram that illustrates an exemplary embodiment of a filter device 100 that can remove particulates and debris from a fluid F. The filter device 100 is part of a filtration system 102 with a filter housing 104 that surrounds a support structure 106. For purposes of the present discussion, the filtration system 102 resides in a power generating system 108 that includes an inlet hood structure 110, ducting 112, and a power source 114 (e.g., a gas turbine). This disclosure also contemplates examples of the filtration system 102 that find use with other types of systems that also require filtration to remove particulates from fluids that pass through the system.

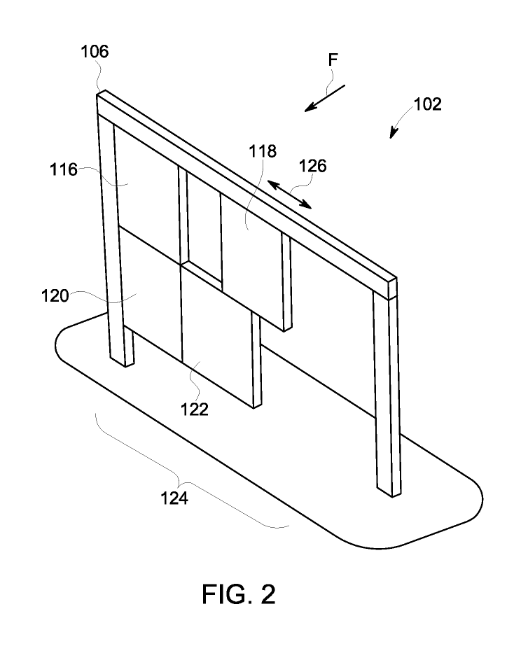

The diagram of FIG. 2 depicts a perspective view to focus the discussion on the filtration system 102. In one example, the filtration system 102 includes a plurality of filter devices (e.g., a first filter device 116, a second filter device 118, a third filter device 120, and a fourth filter device 122) that make up an array or filter bank 124. The filter devices 116, 118, 120, 122 can translate laterally within the filter bank 124, as shown generally by the arrow identified by 126. This features allows the filter devices 116, 118, 120, 122 to traverse the support structure 106 among a variety of positions within the filter bank 124. These positions can include a first position that mates horizontally adjacent filter devices (e.g., the filter device 120 and the filter device 122) and vertically adjacent filter devices (e.g., the filter device 116 and the filter device 120). The positions can also include a second position at which at least one of the filter devices (e.g., the filter device 118) is spaced apart and/or separated from one of the other filter devices (e.g., the filter device 116).

Mating of the filter devices 116, 118, 120, 122 can prevent fluid F from penetrating through the filter bank 124 to areas downstream of the filtration system 102. As set forth more below, the proposed structures for the filter devices 116, 118, 120, 122 can incorporate elements that create a barrier to the flow of fluid F in the first position. This feature ensures filtration of the incoming fluid F by, for example, providing only one path for the fluid F to traverse the filter bank 124, i.e., through the filter media and/or area of the filter devices 116, 118, 120, 122. Moreover, in one example, the proposed structure can also engage one another to secure the filter devices 116, 118, 120, 122 without the need for fasteners (e.g., bolts, screws, clips, etc) that require unfastening during repair and maintenance.

Examples of proposed filter devices also work in conjunction with the support structure 106 to maintain the position and structural integrity of the filter bank 124 with the flexibility to translate the filter devices as desired. For example, elements on the filter devices and on the support structure can permit rolling and/or low-friction sliding of the filter devices 116, 118, 120, 122. This design eliminates the need to lift and extract the filter devices from individual locations within the filter bank 124. On the other hand, this disclosure contemplates designs that allow the filter devices to translate to and from a central location, e.g., one end of the support structure 106. To facilitate movement, the configuration may incorporate an actuator assembly (e.g., a motor and pulley) that imparts force onto the filter devices. For purposes of removing the filter devices from the filter bank 124, the actuator assembly can impart a force that moves the filter devices toward the central location. A technician can extract the filter devices in sequence (e.g., the filter device 118 first, then the filter device 116 second, etc) at the central location. Often, the extraction process can occur without the need to move from location-to-location within the filter bank 124. To install new filter devices, the technician can insert the new filter devices into the filter bank one at a time (e.g., the filter device 116 first, then the filter device 118 second, etc.). In one example, each successive filter device translates or “pushes” the prior-installed filter devices into position within the filter bank 124. When in use, the actuator assembly can impart a force that moves the filter devices into position in the filter bank 124.

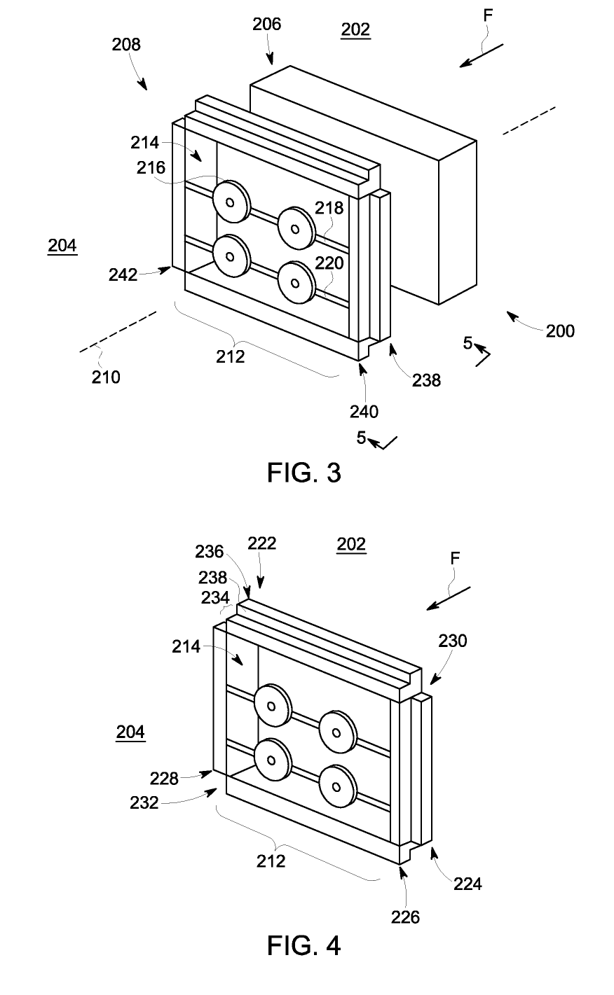

FIG. 3 depicts a perspective, exploded assembly view of an exemplary embodiment of a filter device 200 that can remove particulates and debris from a fluid F. The filter device 200 has an upstream side 202 and a downstream side 204, the orientation of which depends on the direction of flow of the fluid F. As shown in FIG. 3, the filter device 200 includes a filter element 206 and a support element 208 that align on a longitudinal axis 210. The filter element 206 may include a filter media that filters the fluid F as the fluid F passes through the filter media from the upstream side 202 to the downstream side 204.

The support element 208 includes a filter frame 212 that forms a filter receiving area 214. The filter frame 212 has an opening and/or aperture on the upstream side 202 to allow the filter element 206 to insert into the filter receiving area 214. On the downstream side 204, the support element 208 also includes a transitory assembly that secures with the filter frame 212. The transitory assembly facilitates motion of the filter device 200 when, in one implementation, the filter device 200 is in position, e.g., as part of a filtration system (e.g., filtration system 102 of FIGS. 1 and 2). The transitory assembly includes one or more transitory elements 216 that provide rolling and/or sliding translation. In one example, the transitory elements 216 are spaced interior of the filter frame 212, e.g., in the path of fluid F that passes through the filter element 206. In one example, the transitory assembly also includes one or more downstream frame members (e.g., a first downstream frame member 218 and a second downstream frame member 220) that can receive the transitory elements 216 thereon. Examples of the frame members 218, 220 span across the flow path of the fluid F from one side of the peripheral frame 212 to the other. In one example, the frame members 218, 220 position the transitory elements 216 to engage structure of a filtration system (e.g., filtration system 102 of FIGS. 1 and 2) that allows the filter device 200 to translate among various positions.

With reference to FIG. 4, the filter frame 212 can include a plurality of frame members (e.g., a first frame member 222, a second frame member 224, a third frame member 226, and a fourth frame member 228) that form, respectively, a top side, a bottom side, a first side, and a second side of the filter frame 212. In one example, the frame members 222, 224, 226, 228 form a first pair of frame members 222, 224 that share a first common corner 230 and a second pair of frame members 226, 228 that share a second common corner 232.

The frame members 222, 224, 226, 228 have a body 234 that forms a protruding element 236 that extends radially away from the filter receiving area 214. In one example, the protruding element 236 circumscribes the periphery of the filter frame 212, forming a single, contiguous structure and/or separate structures (as shown in FIG. 4). The protruding element 236 has a downstream face 238 that is setoff from the downstream side 204 of the frame members 222, 224, 226, 228 on one or more of the top side, the bottom side, the first side, and the second side.

The filter frame 212 affords the filter device 200 with structural stiffness and stability. Examples of the filter frame 212 can comprise metals and high-strength plastics, although any variety of materials may be compatible with the structure and function of the filter device 200. In one example, one or more of the frame members 222, 224, 226, 228 are constructed unitarily, e.g., as a single and/or monolithic unit that can receive the filter element 206 therein. Other examples may require that one or more structural members are formed separately. These individual pieces can comport with assembly using any variety of fasteners (e.g., bolts and screws), adhesives, and welds.

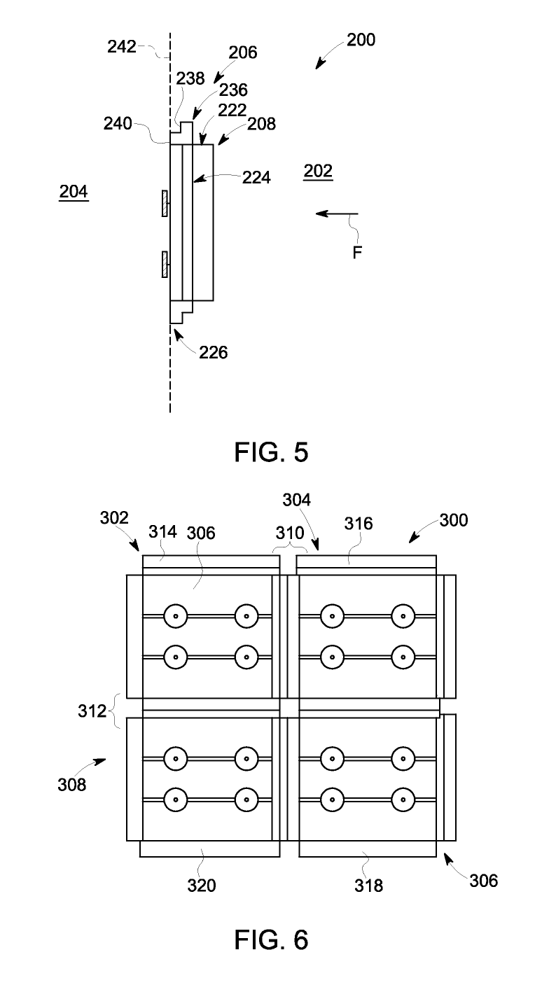

In addition to the “L-shape” illustrated in FIGS. 3 and 4 (and FIGS. 5, 6, and 7 below) the body 234 can embody other shapes that retain and/or incorporate the features and functions of the protruding element 236. These shapes include “Z-shapes” in which the body 234 may include an additional part or portion that extends relatively inwardly toward the interior of the filter frame 212 and in the direction of the longitudinal axis 210. The Z-shape may provide an inner surface that can engage part of the filter element 206 at the peripheral edges to prevent translation of the filter element 206 through the second side.

For purposes of securing the filter element 206 within the peripheral frame 212, one or more of the frame members 222, 224, 226, 228 can include a retention feature that can engage the filter element 206. This retention feature may utilize one or more fasteners (e.g., a screw) that engage the filter element 206 and the peripheral frame 212. More elaborate designs that utilize snaps, clasps, other similar, moveable elements may also reside on the peripheral frame 212 to engage the filter element 206 and secure the filter element 206 in position.

Exemplary devices for use as the transitory elements 216 provide sliding, rolling, and/or low-friction engagement with the support structure of the filtration system. These devices may include rollers, castors, bearings, and similar devices that secure in position on the filter frame 212. These devices can secure, in one example, to the downstream frame members 218, 220 allowing rotation about an axis to facilitate translation (e.g., from the first position to the second position of FIG. 2). In one embodiment, the transitory elements 216 may comprise low friction materials (e.g., thermoplastics) that provide minimal sliding resistance in lieu of rotation. In still other embodiments, the filter frame 212 may incorporate low-friction materials and/or rolling element devices that can facilitate movement as discussed herein.

FIG. 5 illustrates a side view of the filter device 200 in assembled form to discuss the setoff of the protruding element 236. As shown in FIG. 4, the filter frame 212 can have an exposed surface or face 240 that forms a plane 242 on the downstream side 204 of the filter device 200. The protruding elements 236 on the first frame member 222 and the second frame member 224 has a first setoff from the plane 242 in a direction towards the upstream side 202. The protruding element 236 on the third frame member 226 (and, although not shown, the fourth frame member 228 (FIG. 4) can have a second set off, which in the present example is effective zero (i.e., the downstream face 238 on the third frame member 226 (and the fourth frame member 228) is effectively flush and/or planar with the plane 242).

Arranging the protruding elements 236, e.g., with the setoff of the downstream face 238, on the frame members 222, 224, 226, 228 allows filter devices (e.g., filter device 100, 200) to mate and interlock with adjacent filter devices (e.g., filter devices 100, 200) in the filter bank (e.g., filter bank 124 of FIGS. 1 and 2). Moreover, this construction does not necessitate multiple different constructions for the peripheral frame 212. Rather, the filter frame 212 can be oriented in various orientations to position the protruding element 236 to allow the necessary engagement of the adjacent filter devices in the filter bank.

In one embodiment, the protruding element 236 may include an engagement element that cooperates with adjacent filter devices in the filter bank to secure the filter devices together. Examples of this engagement element can couple and decouple, e.g., in response to an input force that meets and/or exceeds the threshold retention force of the engagement element. In one example, the engagement element may comprise a lip and/or protrusion that is disposed on the protruding element 236. The engagement element can have one or more lead-in surfaces that allow the adjacent filter devices to ride up and over the engagement element under sufficient input force.

FIG. 6 depicts a back (or downstream) view of one arrangement of a plurality of filter devices 300 as would be found in a filtration system (e.g., filtration system 102 of FIGS. 1 and 2). In the example of FIG. 6, the arrangement includes a first filter device 302, a second filter device 304, a third filter device 306, and a fourth filter device 308. This arrangement creates one or more areas of engagement (e.g., a first area 310 and a second area 312). In these areas, the filter frames (e.g., a first filter frame 314, a second filter frame 316, a third filter frame 318, and a fourth filter frame 320) of adjacent filter devices meet and/or mate together. The configuration of the first area 310 and the second area 312 blocks (and/or prohibits) the flow of the fluid F (FIGS. 1, 2, 3, and 4) in between the filter devices 302, 304, 306, 308. This feature ensures the flow of the fluid F through the filter element (e.g., filter element 208 of FIGS. 3 and 4), thereby preventing unfiltered air from downstream of the filter devices 302, 304, 306, 308.

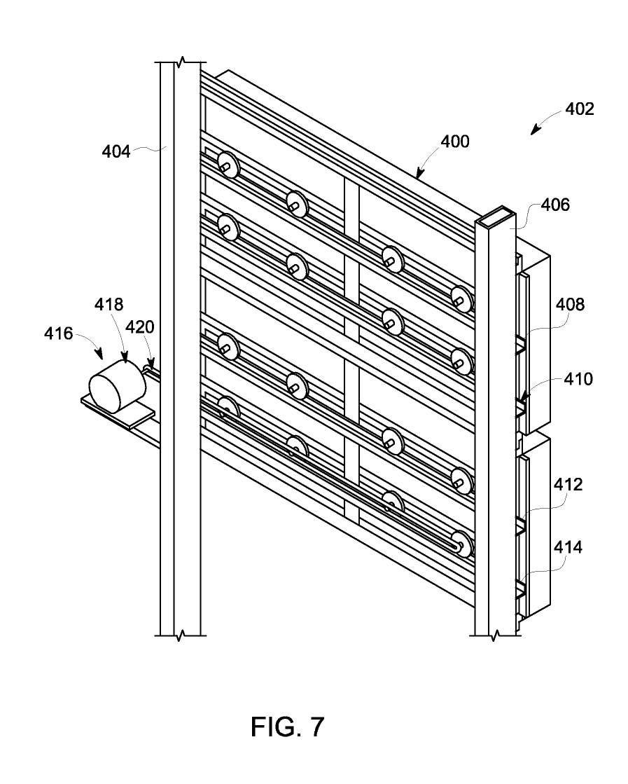

FIG. 7 shows a perspective view of one implementation of filter devices 400 as part of a filtration system 402. The filtration system 402 includes a system structure with one or more upright members (e.g., a first upright member 404 and a second upright member 406) and horizontal channels (e.g., a first channel 408, a second channel 410, a third channel 412, and a forth channel 414). In one embodiment, the filtration system 402 includes an actuator assembly 416 with an actuator 418 and connecting member 420, the combination of which can causes one or more of the filter devices 400 to translate, e.g., along the channel members 408, 410, 412, 414.

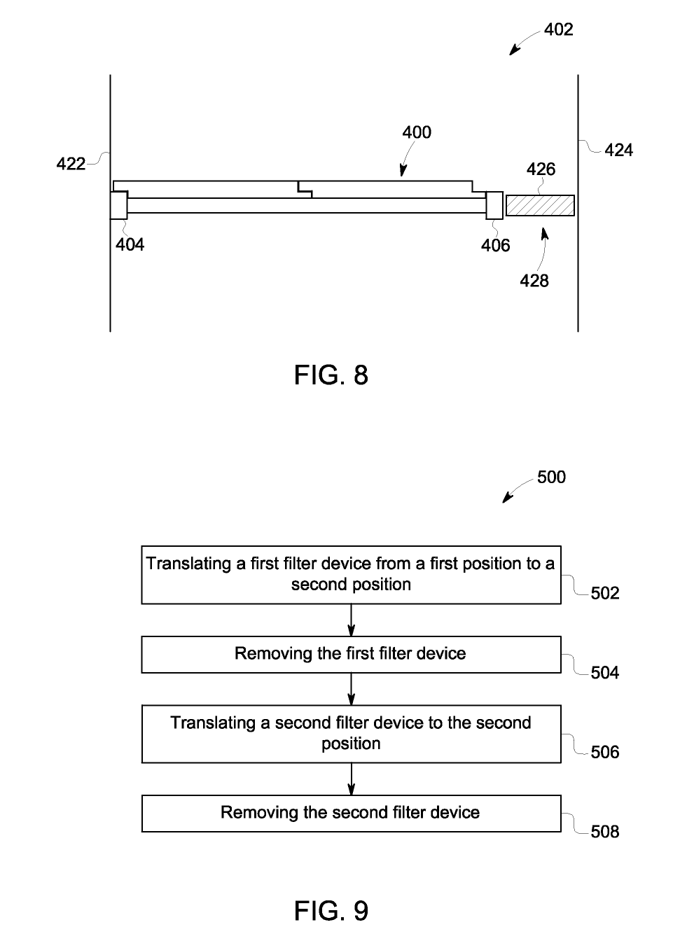

As best shown in FIG. 8, which is a top view of the filtration system 402 in a filter housing (e.g., a filter housing 104 of FIG. 1) with opposing side walls (e.g., a first side wall 422 and a second side wall 424). The position of the filtration system 402 in the filter housing may form a gap 426 or space between one of the side walls 422, 424 and the outer upright members 404, 406. A cover element 428 found in the gap 426 in lieu of a filter device (e.g., filter devices 100, 200, 300, 400) can prevent the flow of fluid F through the gap 426. Examples of the cover element 428 may be the same size as the filter device (e.g., filter devices 100, 200, 300, 400) and/or may extend the entire height of the system structure. During maintenance, the technician can remove the cover element 428 to establish the gap 426. In one example, the gap 426 is sized to allow the technician to remove the filter devices 400 from the system structure and to position new filter devices to slide into the system structure as set forth herein.

FIG. 9 illustrates a flow diagram of a method 500 for performing maintenance on a filtration system (e.g., filtration system 402 of FIGS. 7 and 8). The method 500 includes, at step 502, translating a first filter device from a first position to a second position. The method 500 also includes, at step 504, removing the first filter device from the filtration system. The method 500 further includes, at step 506, translating a second filter device to the second position and, at step 508, removing the second filter device from the filtration system.

Embodiments of the method 500 are useful to remove and replace the filter devices from the system structure in the filtration system. As set forth above, for example, the system structure can arrange filter device in a grid. Translating a first filter device (e.g., at step 502) can move one of the first filter devices to the gap and/or space from which the technician can remove the filter device from the structure. The technician can repeat this step to continue to remove the filter devices, until in one example all of the filter devices in one row of the grid are removed. The technician can slide one or more filter devices into the grid, wherein consecutive filter devices can abut one another to apply the sliding force and move the filter devices laterally across the grid. This process can be used, for example, to remove used, dirty filters from the grid and to insert unused, clean filters into the grid. In one embodiment, the method 500 can include steps for operating an actuator assembly coupled to one or more of the first filter device and the second filter device and for consecutively inserting a third filter device into the support structure and a fourth filter device into the support structure, wherein the third filter device and the fourth filter device translate laterally from the second position into the support structure.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A filter frame, comprising:
a frame having an upstream side and a downstream side, the frame bounding a filter receiving area and forming an opening on the upstream side to receive a filter element into the filter receiving area, the frame comprising a protruding element extending radially away from the filter receiving area; and
a transitory assembly coupled with the frame, the transitory assembly comprising a transitory element disposed on the downstream side of the frame.

2. The filter frame of claim 1, further comprising a downstream frame assembly secured to the frame on the downstream side, wherein the transitory element couples with the downstream frame assembly.

3. The filter frame of claim 2, wherein the downstream frame assembly comprises a plurality of downstream frame members that extend across the filter receiving area.

4. The filter frame of claim 1, wherein the transitory element is spaced interior to the frame.

5. The filter frame of claim 1, wherein the transitory element comprises a plurality of rollers spaced interior to the frame.

6. The filter frame of claim 1, wherein the protruding element extends contiguously about the frame.

7. The filter frame of claim 1, wherein the frame comprises a plurality of frame members that couple with one another to form the filter receiving area.

8. The filter frame of claim 1, wherein the frame includes a plurality of frame members that form, respectively, a top, a bottom, a first side, and a second side of the filter frame, wherein the protruding element has a downstream face that is setoff from the downstream side of the frame members on one of the top, the bottom, the first side, and the second side.

9. The filter frame of claim 8, wherein the downstream face is set off on the bottom and the second side.

10. The filter frame of claim 8, wherein the downstream face is setoff on the top and the first side.

11. A filter frame, comprising:
a frame with an upstream side and a downstream side, the frame comprising frame members forming a peripheral boundary to a filter receiving area in which a filter element can reside, the frame members comprising a protruding element extending radially away from the filter receiving area, the protruding element having a downstream face that is set off from the downstream side on one or more of the frame members; and
a transitory element coupled with the frame and spaced interior to the peripheral boundary.

12. The filter frame of claim 11, wherein the frame members form a top, a bottom, a first side, and a second side, and wherein the downstream face is set off on the top or the bottom.

13. The filter frame of claim 12, wherein the downstream face is set off on the first side or the second side.

14. The filter frame of claim 11, further comprising a first downstream frame member and a second downstream frame member disposed on the downstream side of the frame, wherein the first downstream frame member and the second downstream frame member extend across the filter receiving area.

15. The filter frame of claim 14, wherein the transitory element couples with the first downstream frame member and the second downstream frame member.

16. A method for replacing filter devices in a filtration system having a filter housing and a system structure disposed in the filter housing to support the filter devices, said method comprising:
translating a first filter device from a first position to a second position that is laterally offset from the first position in the system structure;
removing the first filter device from the filtration system at the second position;
translating a second filter device to the second position; and
removing the second filter device from the filtration system at the second position.

17. The method of claim 16, further comprising operating an actuator assembly coupled to one or more of the first filter device and the second filter device.

18. The method of claim 16, wherein the second position corresponds to a gap between a side wall of the filter housing and an upright member of the support structure.

19. The method of claim 16, further comprising consecutively inserting a third filter device into the support structure and a fourth filter device into the support structure, wherein the third filter device and the fourth filter device translate laterally from the second position into the support structure.

20. The method of claim 19, wherein the fourth filter device engages the third filter device in the first position on the support structure.
